(19) United States
(12) Patent Application Publication
(10) Pub. No.: US 2011/0264468 A1
(43) Pub. Date: Oct. 27, 2011

(54) PATIENT ADMINISTRATION SYSTEM COMPRISING INTELLIGENT INTERFACE DEVICE FOR THE TRANSMISSION OF MEDICAL DATA

(76) Inventor: Jurgen Lingmann, Dachau (DE)

(21) Appl. No.: 13/129,895

(22) PCT Filed: Oct. 21, 2009
(86) PCT No.: PCT/EP2009/007538

§ 371 Date: Jul. 18, 2011

(30) Foreign Application Priority Data
Nov. 18, 2008 (DE) 10 2008 057 910.6

(51) Int. Cl. G06Q 50/00; G06F 17/30; G06N 5/00; G06F 13/10

(52) U.S. Cl. 705/3; 710/63; 710/52; 707/792; 706/45; 707/E17.044

(57) ABSTRACT

A patient administration system according to the invention comprises a device which executes a patient administration program, a data source for making medical data available and an interface device which is integrated between the device and the data source and receives data from the data source, converts them to keyboard scan codes which are specific of the patient administration program and outputs said keyboard scan codes to the device. An interface device according to the invention is adapted to be integrated between a device which executes a patient administration program and a data source for making medical data available and receives the data from the data source, converts them to keyboard scan codes which are specific of the patient administration program and outputs said keyboard scan codes to the device. A method according to the invention comprises the following steps: receiving medical data from a data source for making medical data available, converting the medical data to keyboard scan codes which are specific of the patient administration program and outputting the keyboard scan codes to the device.

The present invention relates to a patient administration system and method as well as to an appertaining interface device for the improved communication with a patient administration software.

### BACKGROUND OF THE INVENTION

So-called computer-implemented patient administration systems are used in hospitals, medical centers or medical practices to collect personal basic data such as last name, first name(s), date of birth, gender, health insurance company as well as a unique patient number. Medical histories, results, therapies and other procedures may also be collected. Furthermore, prescriptions and referrals can for example also be written and printed on the basis of such patient administration systems.

Any data exchange between a medical device such as an X-ray device or an ultrasonic device is done by data interfaces designed therefor. Initially, physical data carriers such as floppy disks were used to transmit data from one device to another device but have then been replaced by other communication media such as non-wireless or wireless Fidelity. These data interfaces are based on a defined standard such as ADT, GDT, BDT or HL7 standards. The interfaces are differently implemented in the respective end user software, i.e. the corresponding patient administration system program, as only a few of the interface parameters have been defined in mandatory manner (so-called mandatory fields). For example, in case of the GDT interface just the patient's last name, first name, date of birth, gender, health insurance company and patient number are mandatorily required. Beyond that, many further optional fields have usually been defined or can be defined, e.g. a field for the delivery of blood pressure readings.

As each programmer usually complies only with the absolutely necessary mandatory fields when drafting and programming a patient administration program and defines and also re-defines optional fields (so-called discretionary fields) ad libitum or according to necessity, any data exchange between patient administration systems of different suppliers is difficult or even impossible.

Such a patient administration system is known from DE 100 50 087 A1. A database is here provided on a central processor where already acquired or collected data is stored also including data obtained by the use of medical measuring instruments. Doctors connected to such central processor can said data read out at their PCs. The technology described in this document aims to improve the organization and the communication among scattered medical practices.

To overcome the obstacles described above with regard to data exchange, there are already a number of cooperative bodies aiming to develop a standard interface definition for the direct exchange of data. However, a standard definition for such an interface is related to the problem that as soon as the structure of one interface is amended or even redesigned while being updated, any amendment has to be implemented correspondingly in all interfaces and inspected with regard to compatibility. This results in the disadvantage that the greater part of the effort cannot aim to the further development of the interface but has to be used for inspecting and securing the interfaces among each other.

### ABSTRACT OF THE INVENTION

It is the object of the present invention to improve the data exchange by means of a patient administration system, particularly the input of data into such a patient administration system.

This object is solved by the subject matters of the independent claims. Preferred embodiments are described in the dependent claims.

A patient administration system according to the invention comprises a device which executes a patient administration program, a data source for making medical data available and an interface device which is integrated between the device and the data source and receives data from the data source, converts them to keyboard scan codes which are specific of the patient administration program and outputs said keyboard scan codes to the device.

An interface device according to the invention is adapted to be integrated between a device which executes a patient administration system program and a data source for making medical data available and receives the data from the data source, converts them to keyboard scan codes which are specific of the patient administration program and outputs said keyboard scan codes to the device.

A method according to the invention comprises the following steps: receiving medical data from a data source for making medical data available, converting the medical data to keyboard scan codes which are specific of the patient administration program and outputting the keyboard scan codes to the device.

### BRIEF DESCRIPTION OF THE DRAWINGS

FIG. 1 is a schematic overview of the data interface structure.

FIG. 2 is a schematic view of the structure of the patient administration system according to the invention.

FIGS. 3A and 3B show flowcharts of the method according to the invention.

### DETAILED DESCRIPTION OF THE INVENTIVE EMBODIMENTS

As described above, the invention relates to a patient administration system in which an interface device is integrated between a device which executes a patient administration program and a data source for making medical data available and receives the data from the data source, converts them to keyboard scan codes which are specific of the patient administration program and outputs said keyboard scan codes to the device.

The device executing the patient administration system software can be a commercial computer, but it might also be conceivable to use substantially more powerful servers. To make use of more powerful servers has the advantage that such servers can meet the requirements resulting from increased data amounts in case the patient administration program is used in a hospital, a medical center or in a very large medical practice.

Programs such as MEDISTAR or PDE-TOP can e.g. be used as patient administration programs. Such computer programs which are also known as software for doctors support the administration, organization and operation of medical practices. The functionality of such software for doctors includes patient administration, file keeping, managing of documents, up to the accounting with the health insurance companies. To connect electronic devices to such software is possible, e.g. in order to enter data stored on an insurance card into said software by means of a card reader. Results can also be transmitted electronically.

The interface means or data interface DI is integrated between the device which executes the patient administration software and a data source and receives data, particularly patient data, from the data source. In one embodiment the data from said data source can be transmitted to said interface means by a defined GDT interface, the advantage being in that such interfaces are very common in medical informatics so that such interfaces are available to a great many of data sources. For example, ultrasonic or X-ray devices are provided with GDT interfaces which allows for a rapid and efficient data transfer of at least basic data. In case of an X-ray device, the patient's basic data is generally transmitted via GDT which transmits image data via an interface in accordance with the Dicom-Standard (Digital Imaging and Communications in Medicine). Furthermore, medical data can be entered, in some embodiments, by means of an input device which has been adapted for the input of medical data. Such an input device may be, e.g. a personal computer or a laptop or a tablet PC with graphic input interface, thus providing the advantage that such graphic input interface allows for a time-saving input as the graphic buttons provided on a graphic interface can be easily realized and clicked, thus improving the input speed. Particularly in case the input device is provided with a touch screen such input may not only be done via the mouse or the keyboard but by use of the finger or a stylus provided therefor, thus enabling an even more faster and intuitive input or entry.

The data thus entered is transmitted to the interface device, as described above, via an interface provided therefor. The interface device converts such data to keyboard scan codes which are outputted to the connected device so that they can be entered into the patient administration program. In computer engineering, keyboard scan codes are data transmitted to the computer via the keyboard when a key is either pressed or released. The keyboard scan codes to be used usually depend on the patient administration software used. The software used is communicated to the interface device and the interface device can derive from a chart or table which set of keyboard scan codes is required for this software and can make use thereof correspondingly. This is advantageous in that the interface device can be adapted quickly to any amended patient administration software. A further advantage can be seen in that the input interface of the interface device, i.e. the GDT interface described above, remains unaffected from any change or amendment of the patient administration software used. This enables the user to make inputs or entries into the patient administration system as usual, ideally, the user of the patient administration system will not realize which patient administration software is being used. Hence follows that any exchange of the patient administration program does not entail any retraining in order to be able to handle the new program.

In some embodiments, the interface device functionality can be programmed in a platform-independent programming language, e.g. TCL, so that the interface device is independent of the selected operating system which is especially advantageous when different operating systems such as Windows, Linux and Mac OS are used in a doctor's practice. Owing to the data interface independency of the selected operating system, operation and look-and-feel, i.e. the user feeling, will always be the same, thus doing without settling-in periods for handling the software.

The interface device according to the invention is independent of data structure amendments or changes which might arise in case of end user software updates. If the communication between interface device and patient administration program is done via a predefined interface, such as e.g. the GDT interface, a program update would generally cause a change in the input interface of the patient administration system which would in turn require an update of the interface device. Since the vendor of a patient administration program does usually not unveil the data structure of the input interface, in order to make it harder for any competitors to adapt to any amended data structure, such an amended data structure of the interface device would have to be reconstructed by, e.g. a so-called reverse engineering which would entail a very large expenditure of time. However, as the graphic input mask of the patient administration program is generally not changed to make sure that there is continuity in running the program, the connection of keyboard scan codes for transmitting the input to the PA program has the advantage that it is especially said structure continuity of the graphic input mask that can be utilized.

According to some embodiments, the interface device still has some inherent intelligence, i.e. the data interface is able to classify the different received data and to enter them into the end user software. As to that, the interface device is able to classify the received data in basic categories, such basic categories being, for example, medical histories, results, diagnoses, ICD codes, therapies, procedures, accounting digits and forms. Such listing of basic categories is not final and can be expanded at will, thus providing the advantage to allow for dynamic adaptation to each user's requirements. For example, the requirements of a specialist in orthopedics with regard to the categories used differ to those of a cardiologist or a dermatologist.

In order to detect the category of the corresponding subset of the medical data made available by the data source, in some embodiments the inventive interface device falls back on information that is transmitted together with the data. For example, the basic category may be defined by a prefix placed in front of the medical patient data proper. A blood pressure reading made available by said data source can, for example, be marked by a prefix “RR”. The abbreviation “RR” has just to be regarded as being exemplary. It is common practice to indicate blood pressure readings in such a manner that the first reading being indicated is the systolic pressure and the second reading is the diastolic pressure. The systolic pressure corresponds to the vascular internal pressure while the vessel is expanding, and the diastolic pressure corresponds to the vascular internal pressure while the vessel is contracting, that's why the systolic pressure is always larger than the diastolic pressure. When the measured pressure values are, e.g. 140 and 90, these may be transmitted to the data interface by making use of the character string “RR 140/90”. “RR” is the common abbreviation for Riva-Rocci, an Italian doctor who was the first to describe the inflatable cuff or armlet for measuring the blood pressure. The abbreviation “RR” was introduced in memory of this doctor. Alternatively, the abbreviations “BD” for the German term “Blutdruck” or “BP” for “Blood Pressure” might also be used. As soon as the interface device detects that a character string has been provided that starts with “RR” same can be identified as blood pressure reading. As the user of the PA program knows the section or portion of the input mask where the blood pressure readings are to be entered it is possible, by use of the keyboard scan code, to select the correct input field and to enter the blood pressure readings therein.

Detecting the category belonging to the data made available enables the interface device to inspect or check such data. For example, again by making use of the blood pressure reading described above, the data interface can check out whether the first reading corresponding to the systolic blood pressure is larger than the subsequently following diastolic pressure reading. If not so, it can be assumed that the data made available is incorrect and it will be possible to output a corresponding warning message to the user of the PA system. The advantage is that faulty or incorrect entries can be detected within a narrow time frame, generally immediately after a patient has been examined. In case of any data inconsistency between diagnosis and accounting digit that might occur, for example, not until accounting with the health insurance company is done, which might be a couple of days or weeks after the patient's examination, it will generally be hardly possible to correct such mistake.

Furthermore, the interface device can inspect the validity of the data by means of a set of rules.

In case of such validity check the interface device checks the data by means of a set of rules before the data is transmitted to the end user software, e.g. by examining whether the gathered ICD diagnosis codes match the medications or whether the side localizations in the diagnoses (e.g. left or right knee) match the side localizations of the OPS keys selected by means of the digits. In this connection it is of advantage that such inconsistency within the data set can be detected in time, particularly with regard to the fact that malpractices may thus be avoided. For example, if a diagnose was based on an X-ray image of the right knee, but an operation of the left knee is planned at a later time, the patient administration system according to the invention can output a corresponding warning or error message in due time.

Moreover, it is advantageous that in case of the patient administration system according to the invention it is not required to use the actual interface for the input of data for the PA program. Such interface of the PA program generally is a graphic input mask comprising a number of input fields or screens into which the user can enter patient information. The greater part of PA programs is advertisement-financed, i.e. while data is being entered into the program input interface, unwanted ad pop-ups or any other ads appear. In certain cases, e.g. if migraine was diagnosed for a patient, an ad might pop up recommending the doctor to make use of a special migraine medication.

As in case of some embodiments of the PA system according to the invention medical data input is done via another data source, it is thus possible to evade the ad-afflicted interface. However, a pop-up in the form of an additional window that opens up results in that the input focus changes, i.e. as soon as the ad window has popped up, the input or entry focus no longer is the interface input field selected before but is the ad window with a corresponding key for acknowledging said ad window. This is why in some embodiments the data interface or interface device according to the invention is adapted to detect such change of focus and to react thereto correspondingly. Such corresponding reaction to an ad pop-up might be, for example, to acknowledge said pop-up and then to reset the input focus to the last-visited input field. Beyond, not only an ad pop-up results in an undesired focus change but also error messages or information generated by the operating system. If, for example, a message window pops-up requesting the user to clear up the hard disk which is usual for Windows operating systems when no capacities are hardly available any longer, said window has also to be acknowledged and the input focus has to be reset. Such system error messages can be read out via the corresponding programming interface (application programming interface—API).

In some embodiments, the interface device is adapted to read out from the device the location where data may presently be entered in the current focus window. The current focus window generally has several input fields available into which e.g. the patient's last name, first name and his/her blood pressure readings can be entered. Each of said input fields has a unique ID for its identification, and it is precisely said ID that can be read out in order to determine which one of the input fields is currently active. If, for example, an error message was generated while the patient's basic data were entered and the input, thus, interrupted, it cannot directly be reconstructed which one of the input fields was the cause for such interruption. Reading out the ID of the input field enables to determine where the input or entry can be continued. This is advantageous, as it is not necessary to reset the input mask in order to bring it into a defined state and then transmit the data again completely, but the data input can be continued while reducing the necessary data transmission bandwidth. Furthermore, the contents of the input field may also be inspected, e.g. it can be checked whether the date entered into the input field into which the date of an examination is to be entered corresponds to the current date or to the date of examination.

Moreover, the interface device of certain embodiments is able to store the transmitted data in any modularly selectable database, the advantage being in that should it be necessary to transmit data once again after an interruption or an error message as discussed above, it is possible to fall back on such data. Storing patient data might also help to take any incompatibilities or intolerances between the currently prescribed medications and previously prescribed medications into account. If it is detected, for example, that an anticoagulant was first prescribed for a patient and that painkillers are currently prescribed for the same patient that might also cause blood thinning, a corresponding warning may occur saying that the effects of the two medications will be enhanced. In other cases it might be taken into consideration that the effectiveness of some antibiotic agents might have an undesired influence on the effectiveness of some contraceptive agents so that a corresponding warning can be given. In some embodiments, such database may be an SQL database.

In the following, preferred embodiments will be explained again in detail with special regard to the enclosed drawings.

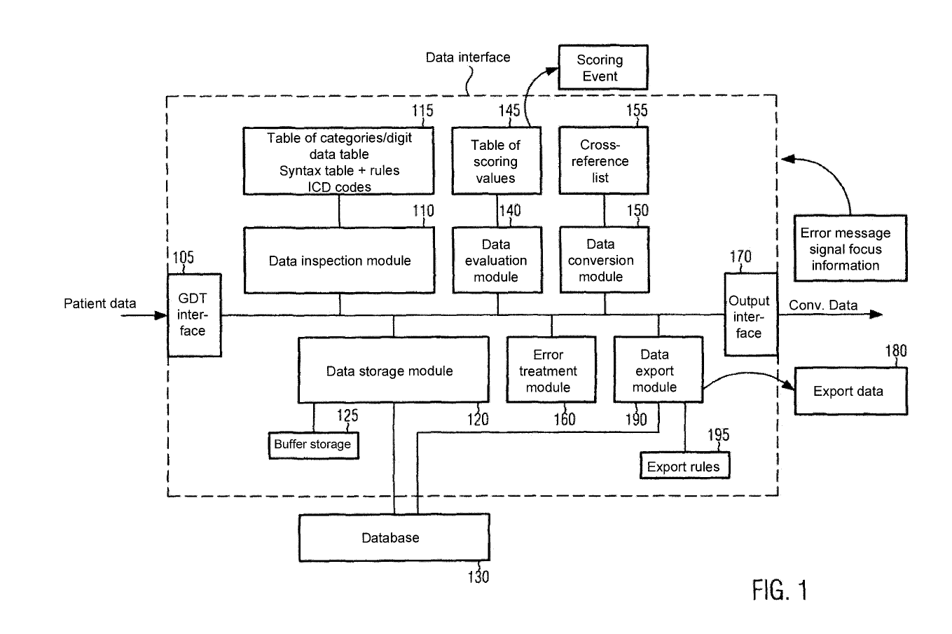

FIG. 1 shows an embodiment of the data interface 100 according to the invention. The data interface receives medical data via an interface 105 which is, in certain embodiments, a GDT interface. Furthermore, the data interface includes a data inspection module 110. Said data inspection module is adapted to inspect or check the received medical data category-wise. In this connection there will be an inspection with regard to the syntax. If the structure of the received data does not correspond to the expected syntax, a corresponding error message can be issued and the input be corrected by the user. In other embodiments, syntax errors may be corrected by the data inspection module independently, e.g. if a blood pressure reading “RR 90/140” has been received, the syntax to be applied, however, requests that the first value must be the larger value, the two numeric values can be exchanged by the data inspection module. The data inspection module obtains the information concerning the syntax and further rules from a table 115. Said table includes categories and digits and rules linked thereto, as well as the basing syntax. ICD codes are also included in table 115.

Further, the interface device comprises a data storage module 120 for storing the received patient data in a storage unit provided therefor. In certain embodiments, the storage unit provided is a database 130. Said database can be separated from the interface device and can be provided, for example, on a database server. Particularly, said database can be, in certain embodiments, an SQL database suited for these purposes.

The interface device of FIG. 1 further shows a data evaluation module which is provided, in certain embodiments, in the interface device. This optional data evaluation module 140 is able to form a patient score by means of a table of scoring values 145 and by taking the patient's data available into account. Such a patient score is a measure for the likelihood of a special disease for this patient. For example, the patient score includes age, gender, bodyweight, blood pressure history over a particular period of time, current diagnoses as well as current results. All these factors are given weighting values which might be empirically determined, and these weighting factors are added up. Such a patient score can be compared to one or several predefined values. If such patient score is, e.g. above a first limit value, a message can be generated recommending to prescribe a special medication for said patient or to suggest him/her a special therapy. If the patient score is above another, larger value it can be recommended to refer the patient to the hospital directly. In some embodiments, such patient score is not generated by the interface device but can be entered from outside, e.g. via the above-mentioned Care engine, into the interface device.

Certain embodiments of the interface device comprise an error treatment module 160. Such error treatment module scans corresponding programming operating system interfaces with regard to any error messages. If there is such an error message it can be clarified whether it was the PA program that generated said error message or whether it was the operating system. If it is an operating system-generated error message, same can be displayed to the user so that he/her is able to treat the operating system-specific error correspondingly. If, however, the error message is a PA program-generated message, further interface device analysis is required, as an error message generated by the PA program might be caused, e.g. by incomplete or faulty data input. In such a case the error code displayed together with the error message will be evaluated. If, according to the error code, the data transmitted to the PA program do not correspond to the expected data, all data belonging to the category currently transmitted can be transmitted again.

As to that, the interface device makes use of a buffer storage 125. Said buffer storage is connected to the data storage module 120. All data determined to be outputted may be stored in said buffer storage in their entirety but may also be stored category-wise, or just one category of said data may be stored therein, the advantage being that it is not necessary to enter the data manually again but that it is also possible to make use of the data contained in said buffer storage.

Moreover, the data interface comprises a data conversion module 150 for converting the received medical data to keyboard scan codes. As to that, it will be determined by means of the category belonging to the corresponding data into which part of the input interface of the PA program said data must be entered and corresponding control codes will be generated. It is possible, for example, to change between the individual input areas by means of a tab key, that's why e.g. one or more keyboard scan codes corresponding to the tab key input may be inserted. This information can be derived from a cross-reference list 155.

Said cross-reference list or keyboard scan code table is used to assign a keyboard scan code to characters or digits to be outputted, i.e. that characters and also control characters are outputted by use of the keyboard scan codes in code form. Moreover, said keyboard scan code table still includes, for some embodiments, the unique IDs described above which are used to mark and read out the input fields. In the keyboard scan code, said IDs are linked to the corresponding appertaining categories, the advantage being in that the IDs of those input fields to be selected while data of a certain category are being transmitted will directly be available.

In certain embodiments, the data conversion module converts the received medical data category-wise to keyboard scan codes, the advantage being in that in case of data transmission failure it is merely the last transmitted category that has to be transmitted again, thus saving transmission bandwidth. The category-wise generated keyboard scan codes are stored, in some embodiments, in buffer storage 125 category-wise.

The interface device according to the invention further comprises, in certain embodiments, a data export module 190 adapted to extract the data stored in the database 130 therefrom, to prepare said data either entirely or partially for the export and finally to output said data in the form of export data 180. Reconditioning of the data of said database is done in accordance with particular export rules 195. It can be determined in said export rules, for example, that data may only be outputted in anonymous form. In such a case the data is outputted without patient names, and instead of a patient name any randomly selected number might be indicated which makes it impossible to give any suggestions with regard to the patient in question. Such exported data might be transmitted to a corresponding API of the device executing the patient administration program to enable the device to send said data via e-mail to a so-called Care engine.

Such Care engine is used to utter a recommendation of treatment by making use of the patient's data, in order to assist the treating doctor preparing his/her treatment plan. Particularly in case of multi-morbid patients, there is a striking increase of time the treating doctor needs to take all interactions of the medications to be prescribed for the individual diseases in their entirety into account. To save time, such work may be done by means of the Care engine adapted therefor which will then in turn give a recommendation of treatment. As already described, such Care engine can be adapted to transmit a patient score to the interface device either alternatively or additionally to such recommendation of treatment.

In certain embodiments, the export data 180 can be transmitted to a system for health services research and not to the Care engine. Health services research systems make use of data rendered anonymous, in order to statically examine the effectiveness of diverse medications on the basis of a large number of patients. A doctor who takes part in such a health services research program has to enter data twice, as patient data has, on the one hand, to be entered into a PA program, yet without any practicable possibility to extract said data from the PA program. Accordingly, any patient data must be entered twice, not only into the PA program but also into a health services research program. Due to such double data input, doctors usually refrain from taking part in such health services research program. In certain embodiments, the interface device according to the invention is advantageous in that such double data collection is no longer necessary and is further advantageous in that such data export can be done via the optional data export module without considerable extra time being required.

The data interface is provided with an output interface 170 for outputting data converted to keyboard scan codes to the device executing the PA program. During the data output the generated keyboard scan codes are injected into an API of the target computer which means that the injected data is taken as keystrokes by said target computer.

Moreover, the error treatment module is able to reset the data collection of the PA program to a defined state. This means that the corresponding keyboard scan codes, i.e. keyboard commands, are transmitted to the end user software thus causing the PA program to reset the input interface to a defined initial state from which data can be entered.

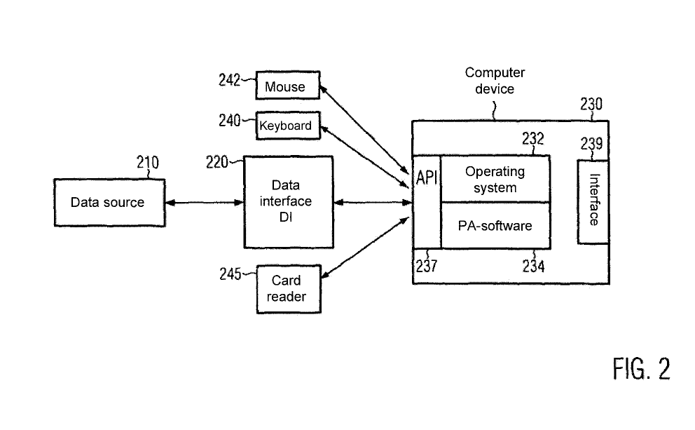

FIG. 2 shows a schematic overview of the patient administration system according to the invention. The computer device 230, i.e. the device which executes the PA software, comprises an operating system 232, the PA software 234, and a programming interface API 237. The system further comprises the interface device or data interface DI 220 and the data source 210. The data source is communicatively connected to the interface device 220 such that the interface device can receive data from said data source and such that, in certain embodiments, the data source can receive error messages generated or transmitted by said interface device. The data source can be, e.g. a medical device with GDT interface or a graphic input means such as a medical tablet PC. The input interface handles the data made available by the data source as described above with regard to FIG. 1. Thereafter, the input interface outputs the data to the programming interface 237 of the computer device 230. The computer device 230 can also be connected to a keyboard 240, a mouse 242 and a card reader 245. In some embodiments, card reader 245 is integrated into the keyboard 240. In certain embodiments, the computer device comprises another interface 239 enabling the computer device to communicate with other computers. For example, the interface 239 may be a network interface according to which data is transmitted via communication protocols such as TCP/IP. The computer device can be connected via said network interface to the above-mentioned health services research server or to a Care engine or, at simplest, to additional computer devices which are constituent parts of a computer network, e.g. in a medical practice or a hospital.

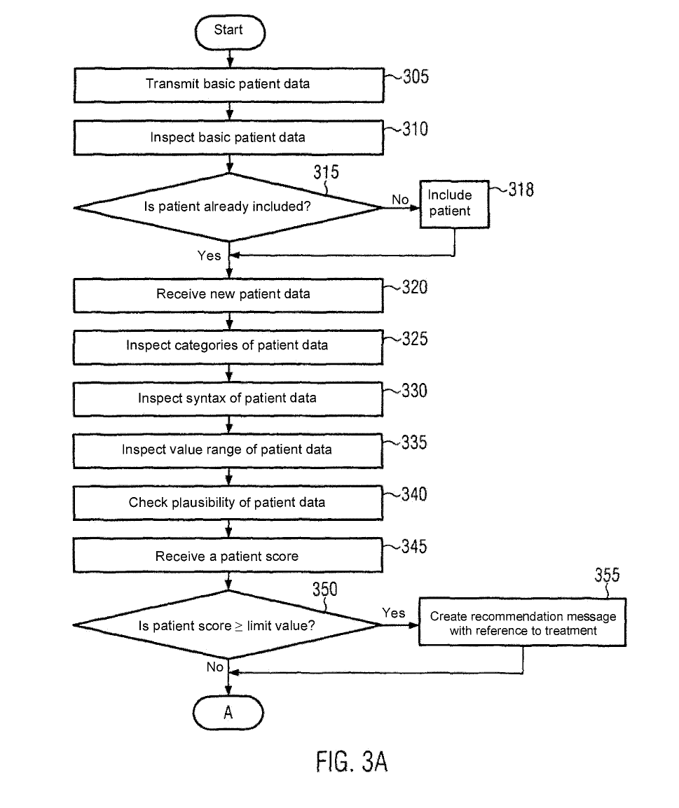

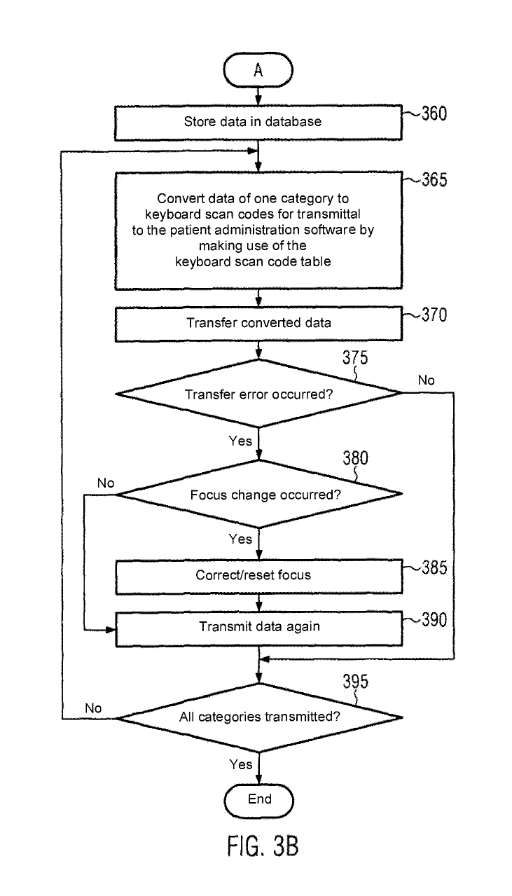

FIG. 3 schematically shows a method according to which embodiments of the patient administration system of the invention can be operated. As is obvious from the above description, not all steps of the described method are substantial for the invention and can, thus, be considered as being optional.

In step 305 basic patient data is transmitted to the input interface. In step 310 said basic patient data is inspected, e.g. with regard to the question whether the patient is already included or not, see step 315. If the patient is not yet included, this will be done in step 318. In step 320 new patient data is received, e.g. via the above-discussed GDT interface. In step 325 the categories of the received data are inspected, e.g. by means of a table of categories or digit data.

In step 330 the syntax of the received data is inspected, e.g. by means of an ICD code table.

In certain embodiments, in step 335 the evaluation areas of the received data are investigated by means of an evaluation area table and corrected, if need be. In step 340 there is a validity or plausibility check of the received data by means of a comparison between ICD codes, OPS keys, digits or medication lists. For example, a comparison of side localizations in the ICD codes and the accounting digits may be conducted here.

In step 345 a patient score is collected, in step 350 such patient score is compared to a limit value. Although just the comparison to the limit value is shown here, in some embodiments a comparison to several limit values is also possible. As soon as the patient score exceeds such limit value, a recommendation message will be generated indicating a special treatment for the patient. Collection of the patient score is generally done by summing up individual weighting factors depending, e.g. on the gender, the age or the blood pressure.

In step 360 the data will be stored in a database.

Subsequently, the patient data will be transmitted category-wise to a target software. In step 365 the data of one category is prepared for the transmission to a patient administration software. To this end, the data is converted to keyboard scan codes by making use of a scan code table. Although not shown in the Figure, step 365 also comprises in some embodiments buffering of keyboard scan codes in a buffer storage. In some embodiments in step 365 also the ID of the input field is entered into which the input is to be made, in order to make sure that the correct input field is used for the input. To this end, said ID is read out from the keyboard scan code table. This can be achieved, for example, by comparison of the ID in the keyboard scan code table with the ID of the current input field.

In step 370 prepared data is transmitted. In step 375 it is inspected whether or not an error occurred during data transmission. If so, it is inspected in step 380 whether or not a focus change occurred. In such a case, the focus is corrected or reset in step 385. If not so, the data is transmitted again. If no error occurred, steps 380, 385, 390 will not be executed. In step 395 it is inspected whether the data of all categories was transmitted. If not so, steps 365 to 395 will be repeated correspondingly. The procedure is terminated as soon as all data has been outputted.

In order to increase the safety of data transmission, the data can be marked in the buffer storage, thus indicating that said data has not yet been transmitted. As long as said mark has not been canceled, it is obvious that the transmission could not yet have been terminated successfully, and only in case of successful transmission of data it can be unmarked. Owing to such mark, the data transmission as well as the data consistency in both the interface device as well as the PA program can be ensured, the advantage being in that in case of a conceivable power failure with accompanying interruption of data transmission, the interface device is able to track which data has been transmitted completely and in which data set of a certain category the error has occurred. This is not only advantageous in case of power failures but also in case of more simple transmission errors, e.g. due to a faulty wire connection between the input interface and the programming interface API of the computer device executing the PA software.

1. A patient administration system, comprising:
a device which executes a patient administration program;
a data source for making medical data available; and
an interface device which is coupled between the device and the data source and receives data from the data source, converts them to keyboard scan codes which are specific of the patient administration program and outputs said keyboard scan codes to the device.

2. The patient administration system of claim 1, wherein the data source is a medical device, and wherein the medical device is an X-ray device or an ultrasonic examination device.

3. (canceled)

4. The patient administration system of claim 1, wherein the data source is a graphic input interface.

5. The patient administration system of claim 1, wherein the interface device is connected to the data source via an interface for the transfer of medical data, and wherein the interface for the transfer of medical data is a GDT interface, a DDT interface or an HL7 interface.

6-14. (canceled)

15. The patient administration system of claim 1, wherein the keyboard scan codes are buffered in a buffer storage.

16-22. (canceled)

23. The patient administration system of claim 1, wherein the interface device stores the data received from the device in a database, wherein the database for storing the data received from said device is an external database,
wherein the external database is run on a database server, and
wherein said database is an SQL database.

24-32. (canceled)

33. An interface device adapted to be integrated between a device which executes a patient administration program and a data source for making medical data available and to receive data from the data source, converts them to keyboard scan codes which are specific of the patient administration program and outputs said keyboard scan codes to the device.

34. (canceled)

35. A patient administration method for operating an interface device which can be connected to a device which executes a patient administration program, the method comprising the following steps:
receiving medical data from a data source for making medical data available;
converting the medical data to keyboard scan codes which are specific of the patient administration program; and
outputting the keyboard scan codes to the device.

35-40. (canceled)

41. The method of claim 35, further comprising:
inspecting at least a portion of the data received from the data source by means of rules, wherein the step of inspecting at least one portion of the received data is done category-wise, and
wherein the categories include medical histories, reports, diagnoses, ICD codes, therapies, accounting digits or forms.

42-43. (canceled)

44. The method of claim 35, wherein the step of converting the medical data to keyboard scan codes is done by means of a cross-reference list, and
wherein the cross-reference list indicates the keyboard scan codes into which the data received from the data source are converted in dependency of the patient administration program used.

45. (canceled)

46. The method of claim 35, wherein outputting of the keyboard scan codes to the device is done category-wise, and
wherein the categories include medical histories, reports, diagnoses, ICD codes, therapies, accounting digits or forms.

47. (canceled)

48. The method of claim 35, wherein outputting of the keyboard scan codes to the device includes the injection of the keyboard scan codes into an API of the device.

49. (canceled)

50. The method of claim 46, wherein the step of outputting the keyboard scan codes category-wise prior to the step of outputting comprises:
marking the keyboard scan codes currently to be outputted in the buffer storage by means of a mark indicating that outputting has not yet been terminated.

51. The method of claim 35, wherein the step of outputting the keyboard scan codes to the device is repeated as soon as the interface device receives an error message from the device with regard to the output of the keyboard scan codes, wherein repeating of the output of the keyboard scan code to the device is done by making use of the keyboard scan codes buffered in the buffer storage.

52. (canceled)

53. The method of claim 48, wherein the method following the step of outputting the keyboard scan codes to the device comprises the following step:
canceling the mark indicating that outputting has not yet been terminated when the interface device does not receive an error message from the device with regard to the output of the keyboard scan codes to the device.

54. The method of claim 35, further comprising:
receiving a patient score,
comparing the received patient score to one or more predefined score values, and
releasing a message as soon as the received patient score exceeds a predefined score value.

55. (canceled)

56. The method claim 54, wherein the message includes a recommendation of treatment or a recommendation for referral to a specialist or to a hospital.

57-60. (canceled)

61. The method of claim 35, further comprising:
outputting the data received from the device to another program, wherein the step of outputting the data received from the device to another program includes outputting the data stored in the database to the other program, and
wherein outputting of data is done in anonymous form.

62-63. (canceled)

64. The method of claim 61, wherein said other program is adapted to output a recommendation of treatment for the patient(s) in response to the data received from the interface device, and
wherein said other program is a Care engine.

65. (canceled)

66. The method of claim 35, further comprising:
inspecting, by making use of a database describing the interaction between medications, the data in one category with regard to possible interactions; and
outputting a message as soon as any possible interaction could have been detected.
